(19) United States
(12) Patent Application Publication
(10) Pub. No.: US 2025/0124660 A1
(43) Pub. Date: Apr. 17, 2025

(54) INFORMATION PROCESSING APPARATUS CAPABLE OF COPING WITH UNPLEASANT AVATAR, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: SEISHIRO IWAHORI, Tochigi (JP)

(21) Appl. No.: 18/910,964

(22) Filed: Oct. 9, 2024

(30) Foreign Application Priority Data
Oct. 16, 2023 (JP) 2023-178206

(51) Int. Cl. G06T 19/00; G06F 3/01

(52) U.S. Cl. CPC G06T 19/00; G06F 3/012; G06F 3/013; G06F 3/017; G06T 2219/024

(57) ABSTRACT

An information processing apparatus that processes information in a virtual space. A user information acquisition section sets a user using the information processing apparatus as a main user and acquires user information of the main user. An avatar information acquisition section acquires main avatar information of a main avatar expressing the main user in the virtual space and other-avatar information of another avatar expressing another user different from the main user in the virtual space. An entry-prohibited avatar determination section determines whether or not the other avatar is a specific avatar based on at least the user information. In a case where it is determined that the other avatar is the specific avatar, an entry-prohibited avatar countermeasure section performs processing for the specific avatar.

### BACKGROUND OF THE INVENTION

### Field of the Invention

The present invention relates to an information processing apparatus that is capable of coping with an unpleasant avatar, a method of controlling the information processing apparatus, and a storage medium.

### Description of the Related Art

There is a technique of causing a user to feel a sensation different from the reality, by performing image processing on an image (captured image) captured from an object existing in a real space. As this technique, Extended Reality (XR) is known. Further, a representative apparatus (device) for displaying an image to which the XR technique is applied is a head-mounted display (HMD) used in a state attached to a person's head. By using the HMD, a user can feel metaverse. On the metaverse, each user can set an avatar as another character of himself/herself and act as the avatar. Further, users around the world can participate in the metaverse. Therefore, as the users participating in the metaverse increase, avatars existing in the metaverse also increase. In this case, a situation in which an avatar of one user harasses an avatar of another user also increases, and as a result, comfortable activities of the other users can be inhibited. In related art literature “Introducing a Personal Boundary for Horizon Worlds and Venues”, Meta Quest Blog|Posted by Vivek Sharma, Vice President, Horizon|Feb 4, 2022 <https://www.meta.com/blog/quest/introducing-a-personal-boundary-for-horizon-worlds-and-venues/?Locale=ja>, there is disclosed a technique in which a boundary of an area within a certain radius from an avatar of one user as a center is set as a personal boundary, and in a case where an avatar of another user intends to enter the personal boundary, the avatar of the other user is prohibited from moving ahead.

However, in the technique described in the above-mentioned related art literature, in a case where an avatar of another user is an avatar which makes one user feel uncomfortable, even when the avatar of the other user does not intend to enter the personal boundary, the avatar of the other user can continue to be near the avatar of the one user. In this case, the uncomfortable state for the one user is continued.

### SUMMARY OF THE INVENTION

The present invention provides an information processing apparatus that is capable of performing processing for keeping a specific avatar away from an avatar of a user using the information processing apparatus or notifying the user of presence of the specific avatar, for example, in a case where the specific avatar is an avatar which makes the user feel uncomfortable. Further, the present invention provides a method of controlling the information processing apparatus and a storage medium, which make it possible to perform the processing as described above.

In a first aspect of the present invention, there is provided an information processing apparatus that processes information in a virtual space, including one or more processors and/or circuitry configured to set a user using the information processing apparatus as a first user, and execute user information acquisition processing for acquiring user information of the first user, execute avatar information acquisition processing for acquiring first avatar information of a first avatar expressing the first user in the virtual space and second avatar information of a second avatar expressing a second user different from the first user in the virtual space, execute determination processing for determining, based on at least the user information, whether or not the second avatar is a specific avatar, and execute processing on the specific avatar, in a case where it is determined, as a result of determination performed by the determination processing, that the second avatar is the specific avatar.

In a second aspect of the present invention, there is provided a method of controlling an information processing apparatus that processes information in a virtual space, including setting a user using the information processing apparatus as a first user, and executing user information acquisition processing for acquiring user information of the first user, executing avatar information acquisition processing for acquiring first avatar information of a first avatar expressing the first user in the virtual space and second avatar information of a second avatar expressing a second user different from the first user in the virtual space, executing determination processing for determining, based on at least the user information, whether or not the second avatar is a specific avatar, and executing processing on the specific avatar, in a case where it is determined, as a result of determination performed by the determination processing, that the second avatar is the specific avatar.

According to the present invention, in a case where a specific avatar is an avatar which makes a user using the information processing apparatus feel uncomfortable, it is possible to perform processing e.g. for keeping the specific avatar away from an avatar of the user or notifying the user of presence of this avatar.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an image processing apparatus (information processing apparatus) according to a first embodiment.

FIG. 2A is a block diagram showing an example of a software configuration of the image processing apparatus.

FIG. 2B is a flowchart showing an example of a process performed by a user information acquisition section of the image processing apparatus, for storing user information in a user information storage section.

FIG. 2C is a flowchart showing an example of a process performed by an other-avatar information acquisition section of the image processing apparatus, for storing other-avatar information in an other-avatar information storage section.

FIG. 2D is a flowchart showing an example of a process performed by an avatar information acquisition section of the image processing apparatus, for storing avatar information in an avatar information storage section.

FIG. 3 is a diagram showing an example of a virtual space displayed on an output section of the image processing apparatus.

FIG. 4 is a flowchart showing an example of a process performed by the image processing apparatus.

FIG. 5 is a flowchart of a process performed by an entry-prohibited avatar countermeasure section of the image processing apparatus.

FIG. 6 is a diagram showing an example of a table of the user information stored in the user information storage section of the image processing apparatus.

FIG. 7 is a flowchart showing an example of a process performed by an entry-prohibited avatar determination section of an image processing apparatus according to a second embodiment.

FIG. 8 is a flowchart showing an example of a process performed by the image processing apparatus.

FIG. 9 is a diagram showing an example of a table of the other-avatar information stored in the other-avatar information storage section.

FIG. 10 is a diagram showing an example of a table of entry-prohibited avatar information stored in an entry-prohibited avatar information storage section.

FIG. 11 is a flowchart showing an example of a process performed by the image processing apparatus according to a third embodiment.

### DESCRIPTION OF THE EMBODIMENTS

The present invention will now be described in detail below with reference to the accompanying drawings showing embodiments thereof. However, the following description of the configuration of the embodiments is given by way of example, and the scope of the present invention is not limited to the described configuration of the embodiment. For example, components of the present invention can be each replaced by a desired one which can exhibit the same function. Further, a desired component can be added. Further, two or more desired components (features) of the embodiments can be combined.

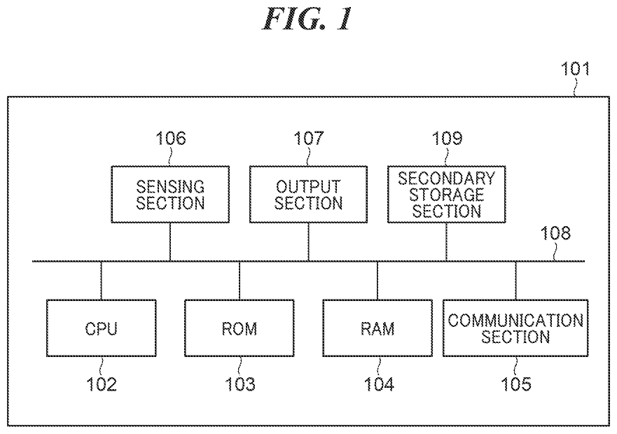

A first embodiment will be described below with reference to FIGS. 1 to 6. FIG. 1 is a block diagram showing an example of a hardware configuration of an image processing apparatus (information processing apparatus) according to the first embodiment. The image processing apparatus shown in FIG. 1, denoted by reference numeral 101, is an apparatus that processes information in a virtual space and is applied to a head-mounted display (HMD) in the present embodiment. Note that the image processing apparatus 101 can be applied not only to the HMD but also e.g. to a desktop-type or laptop-type personal computer, a tablet terminal, and a smartphone. The image processing apparatus 101 includes a central processing unit (CPU) 102, a read only memory (ROM) 103, and a random access memory (RAM) 104. Further, the image processing apparatus 101 includes a communication section 105, a sensing section 106, an output section 107, and a secondary storage section 109. These hardware items included in the image processing apparatus 101 are communicably connected to each other via a bus 108.

The CPU 102 is a controller (computer) that controls the operations of the ROM 103, the RAM 104, the communication section 105, the sensing section 106, and the output section 107. The ROM 103 stores a variety of programs, operation conditions for the above-mentioned operations, and so forth. The programs include a program for causing the CPU 102 to execute operations of the components and means of the image processing apparatus 101, and the like. The RAM 104 is also used as a work memory for storing temporary data for the processing executed by the CPU 102. The communication section 105 is an external interface that performs communication with an external apparatus, such as a server. The sensing section 106 acquires user information concerning a user who uses the image processing apparatus 101, i.e. wears the image processing apparatus 101 on his/her head in a real space. The user information is not particularly limited but includes information concerning at least one of vital signs, a line of sight, a gesture, a facial expression, and so forth, of the user. The vital signs refer to a heart rate, a respiration rate, a blood pressure value, and so forth. The output section 107 is formed e.g. by a liquid crystal display and has a function of a display unit that displays an image of a virtual space, and the like. The secondary storage section 109 can store identification information for identifying a specific avatar, described hereinafter, and so forth, in advance. The secondary storage section 109 is not particularly limited but, for example, a hard disk drive (HDD), a solid state drive (SSD), or the like can be used.

Note that the hardware configuration of the image processing apparatus 101 is not limited to the configuration shown in FIG. 1. For example, the image processing apparatus 101 can include a plurality of CPUs 102 or can further include e.g. a graphics processing unit (GPU). Further, the image processing apparatus 101 includes the ROM 103, the RAM 104, and the secondary storage section 109, as the storage sections, but can further include a tertiary storage section. As the tertiary storage section, similar to the secondary storage section 109, for example, an HDD, an SSD, or the like can be used. Further, the configuration of the bus 108 is not particularly limited, but for example, a multi-stage configuration can be employed to connect the hardware items to each other. In the following description, a user using the image processing apparatus 101 is defined as the main user (first user) and a user who is different from the main user and participates in the same virtual space in which the first user participates is defined as the other user (second user). Further, an avatar expressing the main user in the virtual space is defined as the main avatar (first avatar), and an avatar expressing the other user in the virtual space is defined as the other avatar (second avatar). The main avatar can move within the virtual space according to the operation performed by the main user. The other avatar can move within the virtual space according to the operation performed by the other user.

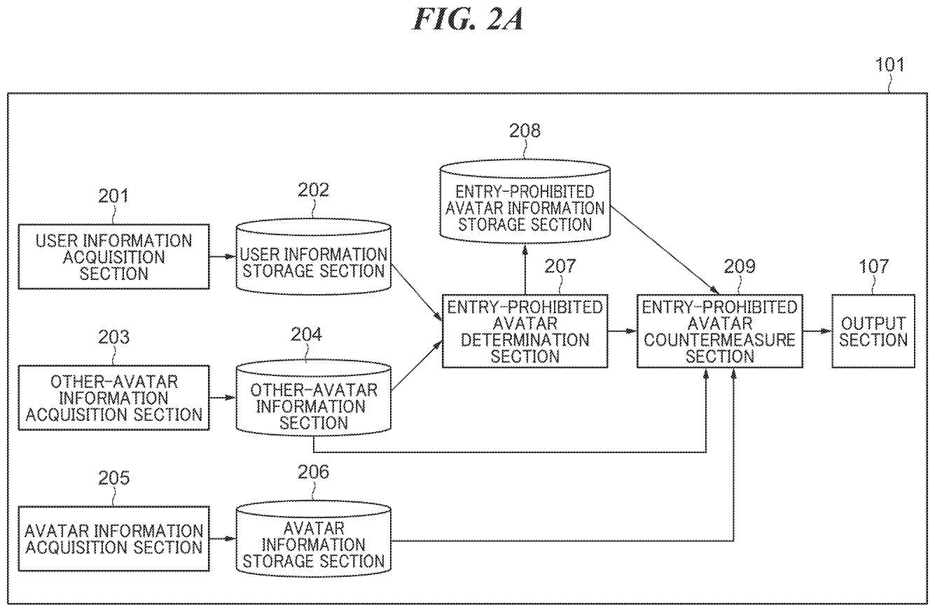

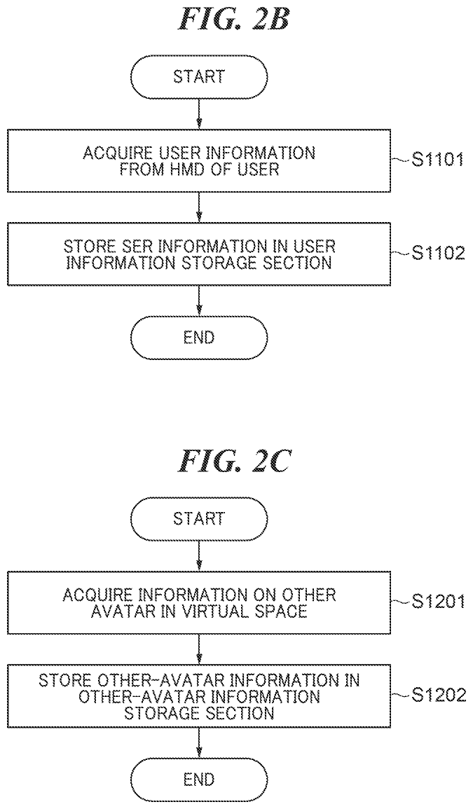

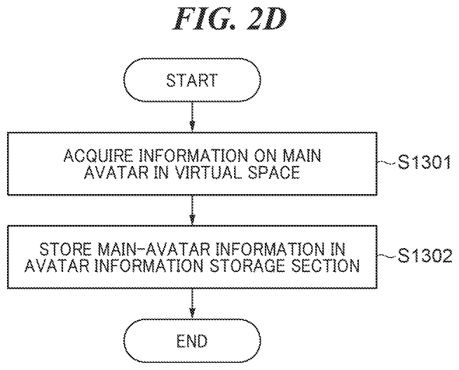

FIG. 2A is a block diagram showing an example of a software configuration of the image processing apparatus. As shown in FIG. 2A, the image processing apparatus 101 includes a user information acquisition section 201, a user information storage section 202, an other-avatar information acquisition section 203, an other-avatar information storage section 204, an avatar information acquisition section 205, and an avatar information storage section 206. Further, the image processing apparatus 101 includes an entry-prohibited avatar determination section 207, an entry-prohibited avatar information storage section 208, and an entry-prohibited avatar countermeasure section 209. The user information acquisition section 201 stores user information of the main user, which is acquired from the sensing section 106 of the image processing apparatus 101 worn by the main user, in the user information storage section 202. As described above, the user information refers to vital signs, a line of sight, a gesture, a facial expression, and so forth. The other-avatar information acquisition section 203 acquires the other-avatar information concerning the other avatar, and stores the acquired other-avatar information in the other-avatar information storage section 204. The other-avatar information is not particularly limited, but, for example, information concerning at least one of a position, an appearance (look), and an action of the other avatar in the virtual space is included. The avatar information acquisition section 205 acquires main avatar information concerning the main avatar, and stores the acquired main avatar information in the avatar information storage section 206. The main avatar information is not particularly limited, but includes, for example, information concerning at least one of a position of the main avatar in the virtual space and conversation between the main avatar and the other avatar. Note that although the other-avatar information acquisition section 203 and the avatar information acquisition section 205 are formed as separate acquisition sections in the present embodiment, this is not limitative, but these acquisition sections can be formed as one acquisition section.

The entry-prohibited avatar determination section 207 determines, based on the vital signs included in the main user information acquired from the user information storage section 202, whether or not values of the acquired vital signs have increased from normal times. The entry-prohibited avatar determination section 207 determines whether or not the value of a vital sign has increased and is equal to or higher than a threshold value. Then, as a result of this determination, if it is determined that the value of the vital signs is equal to or higher than the threshold value, the entry-prohibited avatar determination section 207 determines that the other avatar is an entry-prohibited avatar (specific avatar). This determination is performed based on the sight line information of the main user, which is acquired from the user information storage section 202, and the position information of the other avatar, which is acquired from the other-avatar information storage section 204. Note that if it is determined that the value of a vital sign is lower than the threshold value, the entry-prohibited avatar determination section 207 determines that the other avatar is not an entry-prohibited avatar. Further, the entry-prohibited avatar determination section 207 stores the information on the entry-prohibited avatar in the entry-prohibited avatar information storage section 208. For example, the entry-prohibited avatar countermeasure section 209 sets an entry prohibited area of e.g. 3.5 m between the main avatar and the entry-prohibited avatar. The entry prohibited area is an area where entry of an entry-prohibited avatar is prohibited. The entry-prohibited avatar countermeasure section 209 determines whether or not the main avatar and the entry-prohibited avatar are separated from each other by 3.5 m or more. This determination is performed based on the position information of the main avatar, which is stored in the avatar information storage section 206, and the position information of the entry-prohibited avatar (the other avatar), which is stored in the other-avatar information storage section 204. If it is determined that the main avatar and the entry-prohibited avatar are not separated from each other by 3.5 m or more, the entry-prohibited avatar countermeasure section 209 changes the position of the entry-prohibited avatar in the virtual space to outside the entry prohibited area and gives a warning to the main user and the entry-prohibited avatar (the other user). This warning is given via the output section 107. Further, in a case where the entry-prohibited avatar ignores the warning and approaches the main user, the entry-prohibited avatar countermeasure section 209 prohibits the entry-prohibited avatar from entering the entry prohibited area.

FIG. 2B is a flowchart showing an example of a process performed by the user information acquisition section 201 of the image processing apparatus 101, for storing user information in the user information storage section. This process is performed on each frame of a captured image. As shown in FIG. 2B, in a step S1101, the user information acquisition section 201 acquires the user information of the main user, which is acquired from the sensing section 106 of the image processing apparatus 101 (HMD of the user), and the process proceeds to a step S1102. In the step S1102, the user information acquisition section 201 stores the user information acquired in the step S1101 in the user information storage section 202, followed by terminating the process.

FIG. 2C is a flowchart showing an example of a process performed by the other-avatar information acquisition section 203 of the image processing apparatus 101, for storing other-avatar information in the other-avatar information storage section 204. This process is performed on each frame of the captured image. As shown in FIG. 2C, in a step S1201, the other-avatar information acquisition section 203 acquires the other-avatar information (including the position of the other avatar) concerning the other avatar existing in the virtual space, and the process proceeds to a step S1202. In the step S1202, the other-avatar information acquisition section 203 stores the other-avatar information acquired in the step S1201 in the other-avatar information storage section 204, followed by terminating the process

FIG. 2D is a flowchart showing an example of a process performed by the avatar information acquisition section 205 of the image processing apparatus 101, for storing avatar information in the avatar information storage section 206. This process is performed on each frame of the captured image. As shown in FIG. 2D, in a step S1301, the avatar information acquisition section 205 acquires the main avatar information (including the position of the avatar) concerning the main avatar existing in the virtual space, and the process proceeds to a step S1302. In the step S1302, the avatar information acquisition section 205 stores the main avatar information acquired in the step S1301 in the avatar information storage section 206, followed by terminating the process.

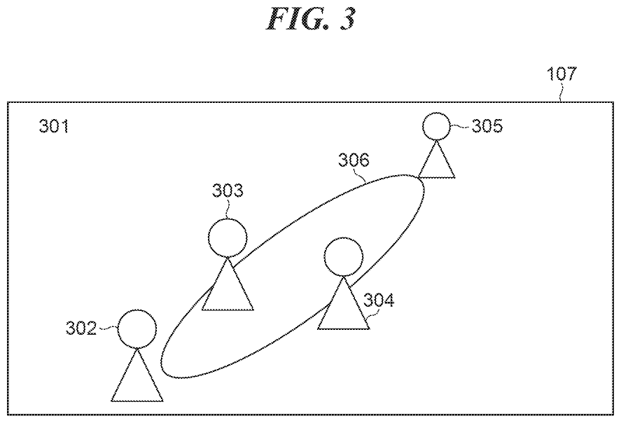

FIG. 3 is a diagram showing an example of the virtual space displayed on the output section 107 of the image processing apparatus 101. In a virtual space 301 shown in FIG. 3, a main avatar 302, another avatar 303, another avatar 304, another avatar 305, and an entry prohibited area 306 are included. The other avatar 305 is an entry-prohibited avatar which is an avatar operated by another user and makes the main user operating the main avatar 302 feel uncomfortable, such as an avatar which is likely to harass or has harassed the main user. The entry prohibited area 306 is set between the main avatar 302 and the other avatar 305 which is the entry-prohibited avatar. This makes it possible to prevent the other avatar 305 from approaching the main avatar 302, whereby the problem of uncomfortable feeling of the main user can be resolved. Note that the other avatar 303 and the other avatar 304 are allowed to enter the entry prohibited area 306.

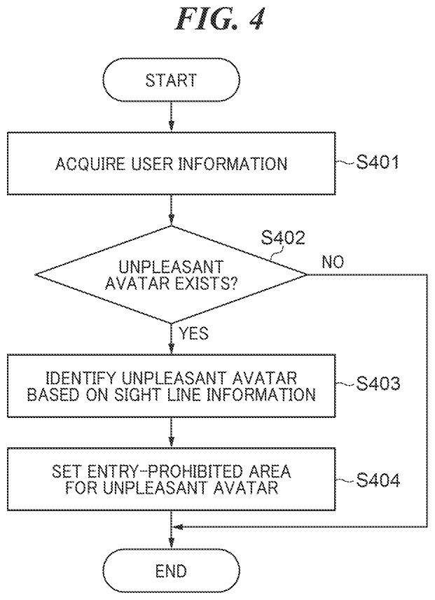

FIG. 4 is a flowchart showing an example of a process performed by the image processing apparatus 101. As shown in FIG. 4, in a step S401, the entry-prohibited avatar determination section 207 acquires the user information of the main user, i.e. the vital signs and the sight line information from the user information storage section 202.

In a step S402, the entry-prohibited avatar determination section 207 determines, based on the vital signs acquired in the step S401, whether or not an avatar which is uncomfortable to the main user, i.e. an avatar as an entry-prohibited avatar is present. This determination is performed based on whether or not any of the heart rate, the respiration rate, and the blood pressure value, which are the vital signs, has increased from normal times and is equal to or higher than the threshold value. In a case where the value of any of the vital signs is equal to or higher than the threshold value, it is determined that an avatar which is uncomfortable to the main user is present, whereas the value of none of the vital signs are equal to or higher than respective threshold values, it is determined that no avatar which is uncomfortable to the main user is present. Note that it is preferable that the threshold values can changed as required. Then, if it is determined in the step S402 that an avatar which is uncomfortable to the main user is present, the process proceeds to a step S403. On the other hand, if it is determined in the step S402 that no avatar which is uncomfortable to the main user is present, the present process is terminated.

In the step S403, the entry-prohibited avatar determination section 207 acquires the position information of the other avatar from the other-avatar information storage section 204. Then, the entry-prohibited avatar determination section 207 identifies the entry-prohibited avatar based on the sight line information acquired in the step S401 and the position information of the other avatar, which are acquired from the other-avatar information storage section 204. For example, in a case where another avatar as an unpleasant avatar is present in a gaze direction of the main user in the virtual space, this other avatar is identified as an entry-prohibited avatar. Further, the information concerning the entry-prohibited avatar is stored in the entry-prohibited avatar information storage section 208.

In a step S404, the entry-prohibited avatar countermeasure section 209 sets an entry prohibited area for preventing the entry-prohibited avatar determined in the step S403 from approaching within 3.5 m from the main avatar.

Thus, in the image processing apparatus 101, in a case where the other avatar is determined as the entry-prohibited avatar, the processing for the entry-prohibited avatar is performed. Then, as the processing for the entry-prohibited avatar, the processing for setting the entry prohibited area for prohibiting entry of the other avatar, between the main avatar and the other avatar in the virtual space is performed, followed by terminating the present process.

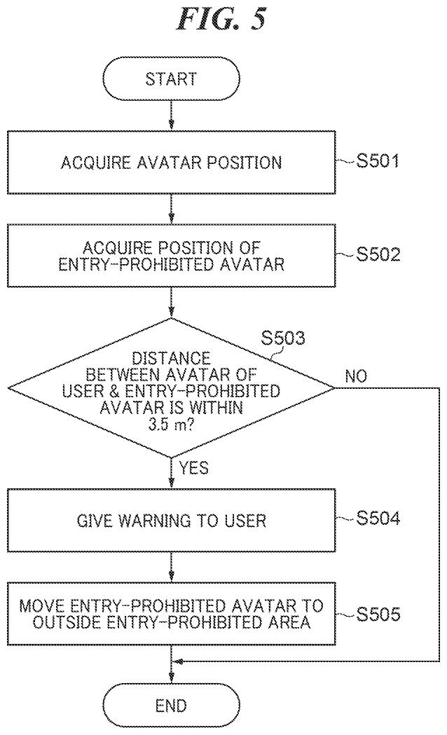

FIG. 5 is a flowchart showing an example of a process performed by the entry-prohibited avatar countermeasure section of the image processing apparatus. The process in FIG. 5 is executed after execution of the process in FIG. 4. As shown in FIG. 5, in a step S501, the entry-prohibited avatar countermeasure section 209 acquires the position information of the main avatar in the virtual space from the avatar information storage section 206.

In a step S502, the entry-prohibited avatar countermeasure section 209 acquires, based on information on the other avatar, which coincides with the information on the entry-prohibited avatar stored in the entry-prohibited avatar information storage section 208, the position information of the other avatar from the other-avatar information storage section 204.

In a step S503, the entry-prohibited avatar countermeasure section 209 determines whether or not the entry-prohibited avatar is present in the entry prohibited area, specifically, whether or not a distance between the main avatar and the entry-prohibited avatar is less than 3.5 m. This determination is performed based on the position information of the main avatar in the virtual space, which is acquired in the step S501, and the position information of the other avatar (entry-prohibited avatar) in the virtual space, which is acquired in the step S502. Then, if it is determined in the step S503 that the entry-prohibited avatar is present in the entry prohibited area, the process proceeds to a step S504. On the other hand, if it is determined in the step S503 that the entry-prohibited avatar is not present in the entry prohibited area, the present process is terminated.

In the step S504, the entry-prohibited avatar countermeasure section 209 displays a warning to the effect that an unpleasant avatar is present, on the output section 107. With this, the main user can be aware that an unpleasant avatar is present.

In a step S505, the entry-prohibited avatar countermeasure section 209 changes the position of the entry-prohibited avatar, to outside the entry prohibited area, followed by terminating the present process.

Thus, in the image processing apparatus 101, in a case where an entry-prohibited avatar is present in the entry prohibited area, i.e. has entered the entry prohibited area, it is possible, as the processing for the entry-prohibited avatar, to notify the main user that the entry-prohibited avatar is present in the entry prohibited area. Further, in combination with this notification, it is also possible to change the position of the entry-prohibited avatar to outside the entry prohibition are in the virtual space. With this, in a case where an avatar which makes the main user feel uncomfortable is present in the virtual space, it is possible to perform the processing for keeping this avatar remote from the main user and notifying the main user of presence of this avatar, and as a result, it is possible to resolve the problem of the uncomfortable feeling. Further, even though the position of the entry-prohibited avatar has been changed to outside the entry prohibited area, in a case where the entry-prohibited avatar moves toward the entry prohibited area, it is preferable that the entry-prohibited avatar countermeasure section 209 prohibit the entry-prohibited avatar from further moving. This makes it possible to further resolve the problem of the uncomfortable feeling of the main user.

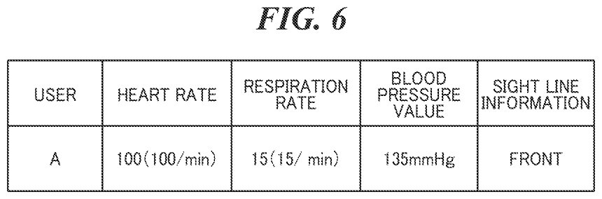

FIG. 6 is a diagram showing an example of a table of the user information stored in the user information storage section 202 of the image processing apparatus 101. Referring to FIG. 6, as the user information of the main user named “A”, a heart rate of “100/min”, a respiration rate of “15/min”, a blood pressure value (highest blood pressure value) of “135 mmHg”, and sight line information of “the sight line is directed to the “front”” are included. As described above, these information items are used when an entry-prohibited avatar is determined. Note that although the vital signs are used for the determination of an entry-prohibited avatar in the present embodiment, this is not limitative, but, for example, a gesture can be used. As the gesture in this case, for example, a gesture can be used in which the main user extends his/her hand toward the front to stop the other avatar. Further, a facial expression of the main user can also be used. As the facial expression in this case, for example, a facial expression of narrowing eyes, a facial expression of frowning (knitting eyebrows), and so forth can be used. Further, although in the present embodiment, as the processing for the entry-prohibited avatar, the entry prohibited area is set between the main avatar and the entry-prohibited avatar, this is not limitative. For example, as the processing for the entry-prohibited avatar, processing can be performed which makes the distance between the main avatar and the entry-prohibited avatar larger as the vital sign indicates a higher value.

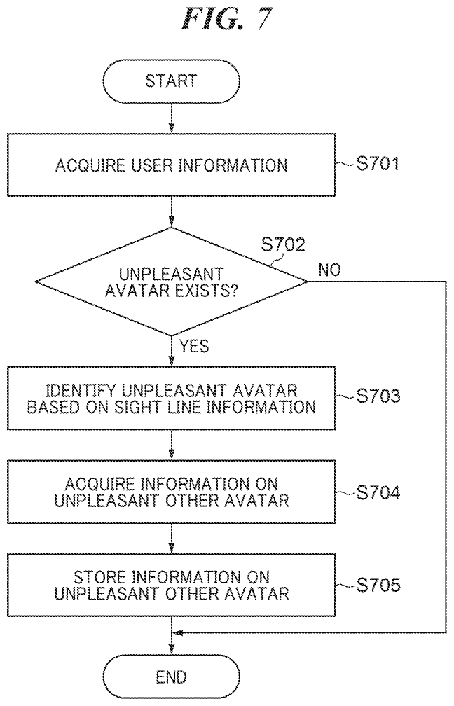

A second embodiment will be described below with reference to FIGS. 7 to 10, but the description is given mainly of different points from the above-described embodiment, and description of the same points is omitted. The present embodiment is the same as the first embodiment except that the method of determining an entry-prohibited avatar is different. FIG. 7 is a flowchart showing an example of a process performed by the entry-prohibited avatar determination section 207 of the image processing apparatus 101 according to the second embodiment. As shown in FIG. 7, steps S701 to S703 are executed. The steps S701 to S703 are the same as the steps S401 to S403 of the flowchart in FIG. 4.

In a step S704, the entry-prohibited avatar determination section 207 acquires information on the action, the appearance, and so forth of the entry-prohibited avatar identified in the step S703, from the other-avatar information storage section 204.

In a step S705, the entry-prohibited avatar determination section 207 stores the information acquired in the step S704 in the entry-prohibited avatar information storage section 208, followed by terminating the present process.

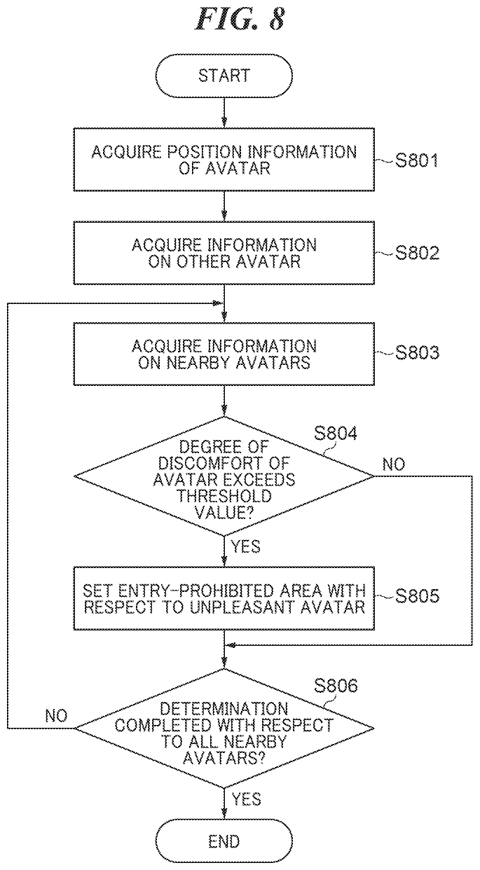

FIG. 8 is a flowchart showing an example of a process performed by the image processing apparatus. This process is performed on each frame of a captured image. Further, the process shown in FIG. 8 is executed after execution of the process in FIG. 7. As shown in FIG. 8, in a step S801, the avatar information acquisition section 205 acquires the position information of the main avatar existing in the virtual space and stores the acquired position information in the avatar information storage section 206.

In a step S802, the other-avatar information acquisition section 203 acquires information on all of the other avatars existing in the same virtual space as the virtual space in which the main avatar exists and stores the acquired information in the other-avatar information storage section 204. The information on the other avatars refers to, for example, information on the action, the appearance, the position, and so forth of each of the other avatars.

In a step S803, the entry-prohibited avatar determination section 207 acquires information on other avatars (nearby avatars) existing within a radius of 5 m (or at a desired position) from the main avatar from the other-avatar information storage section 204.

In a step S804, the entry-prohibited avatar determination section 207 extracts information on one other avatar from the information on all the other avatars (nearby avatars), which is acquired in the step S803. The entry-prohibited avatar determination section 207 calculates, with respect to the extracted information on the other avatar, a degree of discomfort by adding up a similarity of action and a similarity of the appearance of the other avatar, and a value indicating a fact that the other avatar is operated by the same user. Then, the entry-prohibited avatar determination section 207 determines whether or not the calculated degree of discomfort exceeds a threshold value. As a result of this determination, if it is determined that the calculated degree of discomfort exceeds the threshold value, the entry-prohibited avatar determination section 207 determines the other avatar as the entry-prohibited avatar, and notifies the main user of this fact, and the process proceeds to a step S805. On the other hand, if it is determined that the calculated degree of discomfort does not exceed the threshold value, the process proceeds to a step S806.

In the step S805, the entry-prohibited avatar countermeasure section 209 sets an entry prohibited area for the entry-prohibited avatar determined in the step S802.

In the step S806, the entry-prohibited avatar determination section 207 determines whether or not the step S804 has been executed with respect to the information on all of the other avatars (nearby avatars) acquired in the step S803. If it is determined in the step S806 that the step S804 has been executed with respect to the information on all of the other avatars, the present process is terminated. If it is determined in the step S806 that the step S804 has not been executed with respect to information on any of the other avatars, the process returns to the step S803, and the step S803 et seq. are sequentially executed.

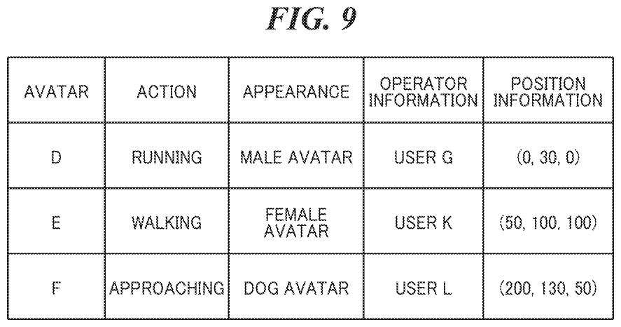

FIG. 9 is a diagram showing an example of a table of the other-avatar information stored in the other-avatar information storage section 204. Referring to FIG. 9, the other avatar information of the other avatar named “D” includes an action of “running”, an appearance of “male avatar”, operator information of “user G”, and position information of “(0, 30, 0)”. Further, the other avatar information of the other avatar named “E” includes an action of “walking”, an appearance of “female avatar”, operator information of “user K”, and position information of “(50, 100, 100)”. Further, the other avatar information of the other avatar named “F” includes an action of “approaching”, an appearance of “dog avatar”, operator information of “user L”, and position information of “(200, 130, 50)”. These information items are used when calculating the degree of discomfort.

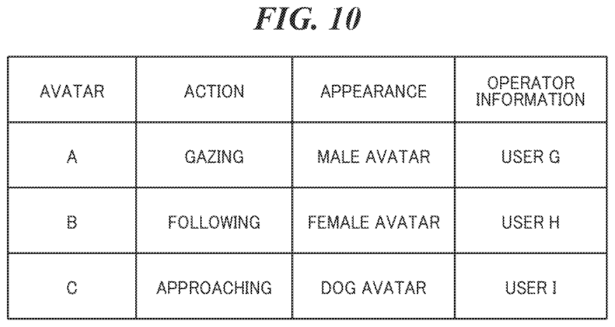

FIG. 10 is a diagram showing an example of a table of the entry-prohibited avatar information stored in the entry-prohibited avatar information storage section. Referring to FIG. 10, the other avatar information of the other avatar named “A” includes an action of “gazing”, an appearance of “male avatar”, and operator information of “user G”. The other avatar information of the other avatar named “B” includes an action of “following”, an appearance of “female avatar”, and operator information of “user H”. The other avatar information of the other avatar named “C” includes an action of “approaching”, an appearance of “dog avatar”, and operator information of “user I”. These information items are information on the action, the appearance, and so forth of the other avatar operated by the other user and determined by the entry-prohibited avatar determination section 207 as an avatar which made the main user feel uncomfortable in the past. Further, these information items are also used when calculating the degree of discomfort.

As described above, in the present embodiment, the similarity between the degree of discomfort, based on the other avatar information stored in the other-avatar information storage section 204, and the degree of discomfort, based on the information (identification information) of the entry-prohibited avatar, stored in the entry-prohibited avatar information storage section 208 is compared. Specifically, the degree of discomfort of the latter of the above is set to a threshold value, and whether or not the degree of discomfort of the former of the above exceeds the threshold value is determined. As a result of this determination, if it is determined the degree of discomfort exceeds the threshold value, the other avatar is determined as the entry-prohibited avatar. As the processing for the entry-prohibited avatar, a notification to the effect that the entry-prohibited avatar is present in the entry prohibited area is provided, and the position of the entry-prohibited avatar in the virtual space is changed. With this, similar to the first embodiment, it is possible to resolve the problem of the uncomfortable feeling of the main user. Note that the degree of discomfort can be calculated based on the history of conversation between the main avatar and the other avatar. Further, the entry-prohibited avatar countermeasure section 209 can be enabled to change the size of the entry prohibited area according to the degree of discomfort. By changing the size of the entry prohibited area, for example, the entry prohibited area can be set to a larger area as the degree of discomfort is higher. With this, it is possible to secure the distance between the main avatar and the entry-prohibited avatar to an extent at which the problem of the uncomfortable feeling of the main user can be solved.

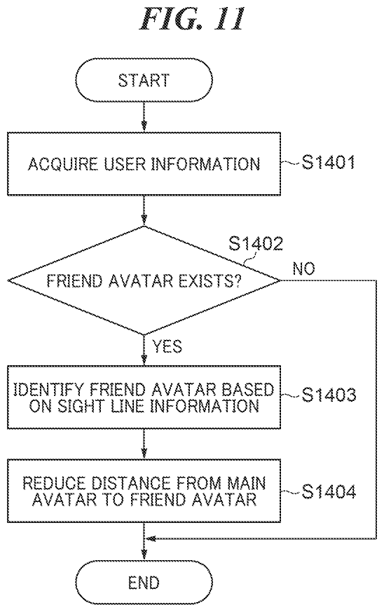

A third embodiment will be described below with reference to FIG. 11, but the description is given mainly of different points from the above-described embodiments and description of the same points is omitted. The present embodiment is the same as the first embodiment except that the processing performed with respect to the specific avatar is different. FIG. 11 is a flowchart showing an example of a process performed by the image processing apparatus 101 according to the third embodiment. As shown in FIG. 11, in a step S1401, the entry-prohibited avatar determination section 207 acquires the user information of the main user, i.e. the vital signs and the sight line information from the user information storage section 202.

In a step S1402, the entry-prohibited avatar determination section 207 determines, based on the vital signs acquired in the step S1401, whether or not a specific avatar is present. The specific avatar in the present embodiment refers to an avatar (specific avatar) which is friendly to the main user, i.e. an avatar which is allowed to enter the entry prohibited area. Note that whether to determine presence/absence of an unpleasant avatar, as in the first and second embodiments, or whether to determine presence/absence of a friendly avatar, as in the present embodiment, is switched by a switching unit (not shown) in advance. Then, the determination of whether or not a friendly avatar is present is performed based on whether or not at least one of the heart rate, the respiration rate, and the blood pressure value, which are the vital signs, has increased from the normal times and is equal to or higher than the threshold value. If at least one of the vital signs is equal to or higher than the threshold value, it is determined that a friendly avatar is present, whereas at least one of the vital signs is lower than the threshold value, it is determined that a friendly avatar is not present. Then, if it is determined in the step S1402 that a friendly avatar is present, the process proceeds to a step S1403. On the other hand, if it is determined in the step S1402 that a friendly avatar is not present, the present process is terminated.

In the step S1403, the entry-prohibited avatar determination section 207 acquires the position information of the other avatar from the other-avatar information storage section 204. Then, the entry-prohibited avatar determination section 207 identifies the friendly avatar present, for example, in the virtual space in the gaze direction of the main user's eyes, based on the sight line information acquired in the step S1401 and the position information of the other avatar, which is acquired from the other-avatar information storage section 204. Further, the information concerning the friendly avatar is stored in the entry-prohibited avatar information storage section 208.

In a step S1404, the entry-prohibited avatar countermeasure section 209 performs processing on the friendly avatar identified in the step S1403 for reducing the distance from the main avatar in the virtual space, followed by terminating the present process. With this, the main user can perform communication with the user who operates the friendly avatar, via the main avatar and the friendly avatar.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-178206 filed Oct. 16, 2023, which is hereby incorporated by reference herein in its entirety.

What is claimed is:

1. An information processing apparatus that processes information in a virtual space, comprising one or more processors and/or circuitry configured to:
set a user using the information processing apparatus as a first user, and execute user information acquisition processing for acquiring user information of the first user;
execute avatar information acquisition processing for acquiring first avatar information of a first avatar expressing the first user in the virtual space and second avatar information of a second avatar expressing a second user different from the first user in the virtual space;
execute determination processing for determining, based on at least the user information, whether or not the second avatar is a specific avatar; and
execute processing on the specific avatar, in a case where it is determined, as a result of determination performed by the determination processing, that the second avatar is the specific avatar.

2. The information processing apparatus according to claim 1, wherein the user information acquisition processing includes acquiring information on at least one of vital signs, a line of sight, a gesture, and a facial expression of the first user, as the user information.

3. The information processing apparatus according to claim 1, wherein the avatar information acquisition processing includes acquiring information on at least one of a position in the virtual space of the first avatar and conversation between the first avatar and the second avatar, as the first avatar information, and acquiring information on at least one of a position in the virtual space, an appearance, and an action of the second avatar, as the second avatar information.

4. The information processing apparatus according to claim 1, wherein the user information acquisition processing includes acquiring information on at least one of vital signs, a line of sight, a gesture, and a facial expression of the first user, as the user information, and
wherein the avatar information acquisition processing includes acquiring information on at least one of a position in the virtual space of the first avatar and conversation between the first avatar and the second avatar, as the first avatar information, and acquiring information on at least one of a position in the virtual space, an appearance, and an action of the second avatar, as the second avatar information.

5. The information processing apparatus according to claim 4, wherein the determination processing includes determining whether or not a value of a vital sign of the first user is equal to or higher than a threshold value, and if it is determined, as a result of the determining, that the value of the vital sign is equal to or higher than the threshold value, determining, based on sight line information of the first user and position information of the second avatar, that the second avatar is the specific avatar.

6. The information processing apparatus according to claim 4, wherein storage processing for storing identification information for identifying the specific avatar in advance is executed,
wherein the determination processing includes determining, based on the second avatar information and the identification information, whether or not the second avatar is the specific avatar.

7. The information processing apparatus according to claim 1, wherein the processing on the specific avatar includes setting an entry prohibited area between the first avatar and the second avatar in the virtual space, for inhibiting the second avatar from entering.

8. The information processing apparatus according to claim 7, wherein the processing on the specific avatar includes, in a case where the second avatar has entered the entry prohibited area, changing the position of the second avatar in the virtual space to outside the entry prohibited area.

9. The information processing apparatus according to claim 8, wherein the processing on the specific avatar includes, in a case where the second avatar moves toward the entry prohibited area even though the position of the second avatar in the virtual space has been changed, inhibiting the second avatar from further moving.

10. The information processing apparatus according to claim 8, wherein the processing on the specific avatar includes, in a case where the second avatar has entered the entry prohibited area, notifying that the second avatar has entered the entry prohibited area is executed.

11. The information processing apparatus according to claim 7, wherein processing for changing the size of the entry prohibited area is executed.

12. The information processing apparatus according to claim 1, wherein the processing for the specific avatar includes reducing a distance between the first avatar and the second avatar in the virtual space.

13. The information processing apparatus according to claim 1, wherein processing for displaying an image of the virtual space is executed.

14. The information processing apparatus according to claim 1, wherein the information processing apparatus is a head-mounted display.

15. A method of controlling an information processing apparatus that processes information in a virtual space, comprising:
setting a user using the information processing apparatus as a first user, and executing user information acquisition processing for acquiring user information of the first user;
executing avatar information acquisition processing for acquiring first avatar information of a first avatar expressing the first user in the virtual space and second avatar information of a second avatar expressing a second user different from the first user in the virtual space;
executing determination processing for determining, based on at least the user information, whether or not the second avatar is a specific avatar; and
executing processing on the specific avatar, in a case where it is determined, as a result of determination performed by the determination processing, that the second avatar is the specific avatar.

16. A non-transitory computer-readable storage medium storing a program for causing a computer to execute a method of controlling an information processing apparatus that processes information in a virtual space,
wherein the method comprises:
setting a user using the information processing apparatus as a first user, and executing user information acquisition processing for acquiring user information of the first user;
executing avatar information acquisition processing for acquiring first avatar information of a first avatar expressing the first user in the virtual space and second avatar information of a second avatar expressing a second user different from the first user in the virtual space;
executing determination processing for determining, based on at least the user information, whether or not the second avatar is a specific avatar; and
executing processing on the specific avatar, in a case where it is determined, as a result of determination performed by the determination processing, that the second avatar is the specific avatar.
